(19) United States
(12) Patent Application Publication
(10) Pub. No.: US 2022/0043557 A1
(43) Pub. Date: Feb. 10, 2022

(54) VIRTUAL OBJECT REGISTRY AND TRACKING PLATFORM

(71) Applicant: Vatom Corporation, Inc., Venice, CA (US)

(72) Inventors: Eric Pulier, Venice, CA (US); Craig C. Sellars, Norcross, GA (US); Gunther Thiel, Walchwil (CH); Lukas Fluri, Basel (CH)

(21) Appl. No.: 17/451,920

(22) Filed: Oct. 22, 2021

Related U.S. Application Data
(63) Continuation of application No. 15/230,327, filed on Aug. 5, 2016.
(60) Provisional application No. 62/341,569, filed on May 25, 2016.
(60) Provisional application No. 62/318,710, filed on Apr. 5, 2016.
(60) Provisional application No. 62/207,134, filed on Aug. 19, 2015.

(51) Int. Cl. G06F 3/0481; G06F 3/0488; G06Q 20/12; G06F 3/01; G06F 3/0484; G06Q 20/02

(52) U.S. Cl. CPC G06F 3/04817; G06F 3/04883; G06Q 20/1235; G06Q 2220/00; G06F 3/011; G06F 3/0484; G06Q 20/02; G06F 3/017

(57) ABSTRACT

Various embodiments of the present technology generally relate to a platform for creating, tracking, modifying, redeeming and destroying unique virtual objects. Some embodiments of the platform allow registered users to create the unique virtual objects and distribute them to an initial population which can trade, modify, combine, separate or otherwise interact with the virtual objects. The platform can track each of the unique virtual objects and their current state as they are transferred, activated, merged, etc. with other virtual objects via a reactor framework within the platform. The platform can also provide an interface for merchants to accept the virtual objects from current owners in exchange for other items (e.g., consumer products, promotional materials, etc.).

### CROSS-REFERENCE TO RELATED APPLICATIONS

This application claims priority to U.S. Provisional Application Ser. No. 62/341,569, filed May 25, 2016, U.S. Provisional Application Ser. No. 62/318,710, filed Apr. 5, 2016, and U.S. Provisional Application Ser. No. 62/207,134, filed Aug. 19, 2015, all of which are incorporated herein by reference in their entireties for all purposes.

### TECHNICAL FIELD

Various embodiments of the present invention generally relate to a virtual object registry and tracking platform. More specifically, the embodiments of the present invention relate to a platform for creating, tracking, modifying, redeeming and terminating unique virtual objects.

### BACKGROUND

Modern mobile electronic devices (such as computers, mobile phones, personal digital assistants, computer tablets, or the like) have become a common part of modern life. Using these devices, individuals are able to create, share and consume digital content as never before. Often the digital content is in the form of advertisements, photographs, articles, audio files, video files, as well as many others. The digital content may be free or may be distributed with a subscription or fee. For example, news articles may be published for free via a website, a subscriber may pay to download an audio or video file for entertainment, or software may require the purchase of a license to be activated.

Digital content can often be easily duplicated, replaced and/or reproduced via the original distribution channels, from backup copies, or from counterfeiters. As a result, the digital content itself is often interchangeable. There is typically no limit on the number of copies that may be available. In contrast to traditional digital content, real-world property is associated with an owner and the owner has the ability to control access to, consume, transfer ownership, or combine the property with other property. Moreover, even similar real-world objects are limited in number and cannot be easily duplicated, replaced and reproduced like the digital content.

While some digital content providers include various digital rights management (DRM) techniques to control the digital content, these DRM techniques usually only control the use, modification, and redistribution of the digital content. These DRM techniques do not allow for ownership transfer or modification of the digital content that originators or users of the content might desire. As such, there are a number of challenges and inefficiencies with traditional digital content and digital content management systems. It is with respect to these and other problems that embodiments of the present invention have been made.

### SUMMARY

Various embodiments of the present technology provide a virtual object registry and tracking platform configured for creating, tracking, modifying, redeeming and/or terminating unique virtual objects. One embodiment of the present technology provides a virtual object platform comprising a processor, and a database having stored thereon multiple virtual customization profiles to guide a creator through the creation of a unique virtual object. The platform has a customization module, under control of the processor, configured to retrieve, from the database, one of the multiple virtual customization profiles to guide the creator through creation of the unique virtual object, and issue the unique virtual object with a unique identifier allowing for identification of the unique virtual object. The platform has a distribution module, under control of the processor, to record the unique virtual object with a blockchain system with an initial ownership. The blockchain system maintains state information of the unique virtual object. An internal reactor, under control of the processor, is configured to receive a request to modify the state information of the unique virtual object, access the blockchain system to retrieve the state information associated with the unique virtual object, and process the request to modify the state information.

Another embodiment of the portfolio provides a computer-readable medium, excluding transitory signals, storing instructions that when executed by one or more processors cause a machine to receive a request to modify a unique virtual object that has state information recorded in a blockchain system, wherein the unique virtual object is associated with a modification rule set governing permissible modifications for the unique virtual object. The state information for the unique virtual object is retrieved from the block chain system, and the request to modify the unique virtual object is processed subject to the modification rule set for the unique virtual object. Updated state information is generated based on any modification to the unique virtual object, and the updated state information is stored on the blockchain system.

Another embodiment provides a method comprising receiving a request to create one or more virtual objects, wherein the request includes a set of properties governing visualization and modification of the one or more virtual objects, creating the one or more virtual objects by assigning each of the one or more virtual objects a unique identifier, and tracking state information of each of the one or more virtual objects as consumers interact with the one or more virtual objects.

Embodiments of the present technology also include computer-readable storage media containing sets of instructions to cause one or more processors to perform the methods, variations of the methods, and other operations described herein.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 is a schematic of a virtual object platform networked with other components in accordance with some embodiments of the present technology;

FIG. 2 illustrates an example of various components of a virtual object platform according to one or more embodiments of the present technology;

FIG. 3 is a schematic of a life cycle of a virtual object according to one or more embodiments of the present technology;

FIG. 4 is a flowchart illustrating a set of operations for operating a virtual object platform according to one or more embodiments of the present technology;

FIG. 5 is a flowchart illustrating a set of operations for tracking a state of a virtual object according to various embodiments of the present technology;

FIG. 6 is a flowchart illustrating a set of operations for exchanging a virtual object for a real-world object in accordance with some embodiments of the present technology;

FIG. 7 is a flowchart illustrating a set of operations for changing ownership of a virtual object in accordance with some embodiments of the present technology;

FIG. 8 is a flowchart illustrating a set of operations for processing gestures detected within a viewer in accordance with various embodiments of the present technology;

FIG. 9 is an example of a viewer allowing a user to interact with multiple virtual objects in accordance with one or more embodiments of the present technology;

FIG. 10 is a sequence diagram illustrating an example of the data flow between various components of a virtual object framework according to various embodiments of the present technology;

FIGS. 11A-11K are screen shots of an example of a collectable trading cards collection created and tracked in accordance with one or more embodiments of the present technology; and

FIG. 12 is an example of a computing platform that may be used in accordance with one or more embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology, as defined by the appended claims.

### DETAILED DESCRIPTION

Various embodiments of the present technology generally relate to a platform for creating, tracking, modifying, redeeming, and destroying unique virtual objects. Unlike traditional digital content, the platform allows for registered providers to create unique virtual objects and distribute them to an initial population of registered users that can trade, modify or otherwise interact using the virtual objects through an application running on a computing device.

The application (called a viewer) can communicate with the platform to determine the current state of the virtual object. Using the state information, the application can allow the consumer to transfer a virtual object to a new owner, activate the virtual object, modifying the virtual object, or merge a virtual object with other virtual objects. These and other activities may be monitored, governed, and/or managed by the virtual object platform. For example, the platform, in some embodiments, can track of each of the unique virtual objects (and their current state). As another example, the platform can also provide an interface for merchants or other redeemers to accept the virtual objects from current owners in exchange for other items (e.g., music, beverages, screenplay, article, food, merchandise, goods, services, virtual animal, virtual good, etc.).

The virtual objects may be static or dynamic (i.e., able to evolve over time, with interactions from the user, in response to external events, etc.). As a result, some embodiments of the platform can maintain the “state” of virtual objects using unique identifiers for tracking. For example, the platform may use a method to codify and establish the possible “states” of a unique virtual object that allows computer programs (called interpreters) to retrieve or calculate the metadata to determine how to react to the virtual object's state. The state tracking of virtual objects can use private and/or public code. For example, some embodiments of the platform can contact a third party system to determine the current attributes of a virtual object, and the method of making changes to these virtual objects such that their new state can be understood by other interpreters.

In order to modify states of the virtual object, the platform may include a variety of autonomous reactors, both remote and locally distributed reactors. These reactors can allow the virtual object to change states and/or become virtually alive by evolving over time (e.g., a virtual plant growing) or in response to interactions with an owner, external events, or other stimuli. The reactors can allow the virtual objects to act independently of their virtual environment but also be affected by it. For example, a virtual fish in a virtual aquarium viewer will be happy, but might flail about and die when transferred to a viewer without virtual water in the aquarium. Reactors can provide a variety of methods by which virtual objects can interact with one another autonomously.

Various embodiments of the platform may allow registered providers to 1) create one or more unique virtual objects, 2) register the unique virtual objects, 3) provide a transparent chain of ownership, 4) set rules governing the modification, evolution, combination, interaction, or other properties or characteristics of the virtual objects, 5) link a virtual object to a real-world object, and 6) initially distribute the virtual objects created by the platform to consumers.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean that the particular feature, structure, or characteristic following the phrase is included in at least one implementation of the present technology, and may be included in more than one implementation. In addition, such phrases do not necessarily refer to the same embodiments or different embodiments.

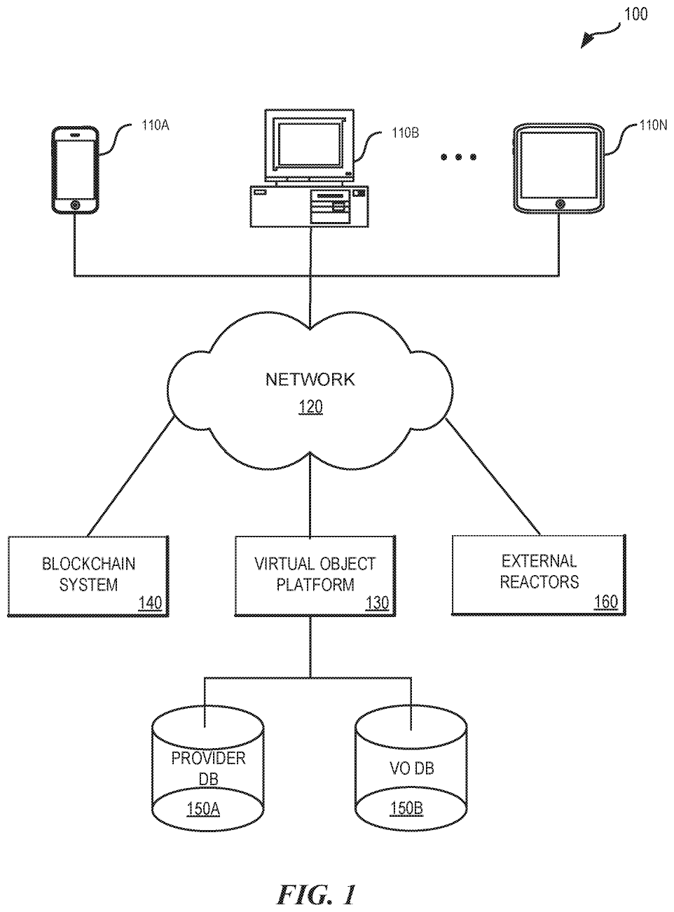

FIG. 1 illustrates an example of a virtual object platform networked with other components in accordance with some embodiments of the present technology. As illustrated in FIG. 1, virtual object platform 130 can be connected to one or more computing devices 110A-110N (such as a mobile phone, tablet computer, mobile media device, gaming device, virtual reality or augmented reality systems, vehicle-based computer, wearable computing device, etc.) using communications network 120. In addition, virtual object platform 130 may be connected to blockchain system 140, virtual object database 150, and one or more external reactors 160.

Computing devices 110A-110N can include network communication components that enable the computing devices to communicate with virtual object platform 130 or other portable electronic devices by transmitting and receiving wireless signals using licensed, semi-licensed or unlicensed spectrum over communications network 120. In some cases, communications network 120 may be comprised of multiple networks, even multiple heterogeneous networks, such as one or more border networks, voice networks, broadband networks, service provider networks, Internet Service Provider (ISP) networks, Public Switched Telephone Networks (PSTNs), and/or interconnected via gateways operable to facilitate communications between and among the various networks. Communications network 120 can also include third-party communications networks such as a Global System for Mobile (GSM) mobile communications network, a code/time division multiple access (CDMA/TDMA) mobile communications network, a third or fourth generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

In some embodiments, computing devices 110A-110N may include components that enable them to connect to a communications network 120 using Generic Access Network (GAN) or Unlicensed Mobile Access (UMA) standards and protocols. For example, a mobile device may include components that support Internet Protocol (IP)-based communication over a Wireless Local Area Network (WLAN) and components that enable communication with the telecommunications network over the IP-based WLAN. Computing devices 110A-110N may include one or more mobile applications that various users can interact with to create, modify, combine, destroy, transfer or otherwise interact with the virtual objects. These applications may need to transfer data or check in with virtual object platform 130 or blockchain system 140.

Virtual object platform 130 can create virtual objects that are each individually unique and therefore scarce. Accordingly, the virtual objects can be created so that no two virtual objects are identical. By creating only a limited number and tracking the ownership of the virtual objects, the platform can allow for virtual objects that are authenticatable, transferable, and/or redeemable for real-world goods. The virtual object platform 130 can also allow for the integration with point of sale (POS) devices because of the virtual object's determinable authenticity. By tracking the virtual objects, various methods can be applied to uniquely identify fungible (yet unique) virtual objects that carry with them individual unique identifiers (such as gold bar serial numbers).

In some embodiments, the methods used by virtual object platform 130 can encode unique metadata about each virtual object that can establish its characteristics and/or categorization. Some embodiments allow for metadata encoding methods. These metadata encoding methods can be used to uniquely identify, manage and track individual virtual objects that represent virtual or real-world items. One feature of this methodology is the use of a block change system or other secure transaction monitoring system to ensure immutability of these virtual objects, while allowing the dynamic management of their creation, issuance, functionality, reactivity to users and the environment, and movement.

Virtual objects created with virtual object platform 130 can be unique and valuable. As a result, creation of virtual objects may be restricted to registered providers in some embodiments. Virtual object platform 130 can include tools and programs that can be used by the providers to create the virtual objects by establishing characteristics, evolutionary rules, software code, and attributes of the virtual objects.

To assist registered providers in creating the virtual objects, some embodiments of virtual object platform 130 can provide a library of templates (also referred to as virtual customization profiles) that the registered providers can use to guide them through the creation of the virtual objects. The virtual customization profiles can allow the registered provider to create or select visual customizations, audio customizations, and content customizations for the unique virtual object. In some embodiments, the virtual customization profiles can allow the registered providers to set one or more rules governing the evolution of the virtual object (e.g., a rule for combining two different virtual objects), to associate software code with the virtual object, create styles, create names, and the like.

Once the virtual object is created, virtual object platform 130 can register the virtual object with blockchain system 140. The registration record can include an initial state of the virtual object along with software code associated with each virtual object. The initial ownership designated within the record may be the registered provider or an individual, business or other entity as designated by the registered provider. Owners of the virtual objects may then use various software applications and/or hardware tools called viewers to access and interact with the virtual objects associated with their account.

The virtual object platform 130 can provide a variety of mechanisms for describing the combination/interaction/separation of multiple virtual objects. For example, some embodiments may use methods and techniques to codify and establish rules by which virtual objects interact with one another, such that an interpreter doesn't have to retrieve rules from a third party. As a result, some embodiments rely entirely on the interaction definitions established upfront. In other embodiments, the interaction definitions may be customized for each virtual object and/or the interactions definitions may change over time. The interactions definitions may have an expiration date/time associated. As such, any interpreter would have to update the interaction definitions after the expiration date/time has passed. In some embodiments, the virtual object may identify a set of interaction definitions which govern interactions.

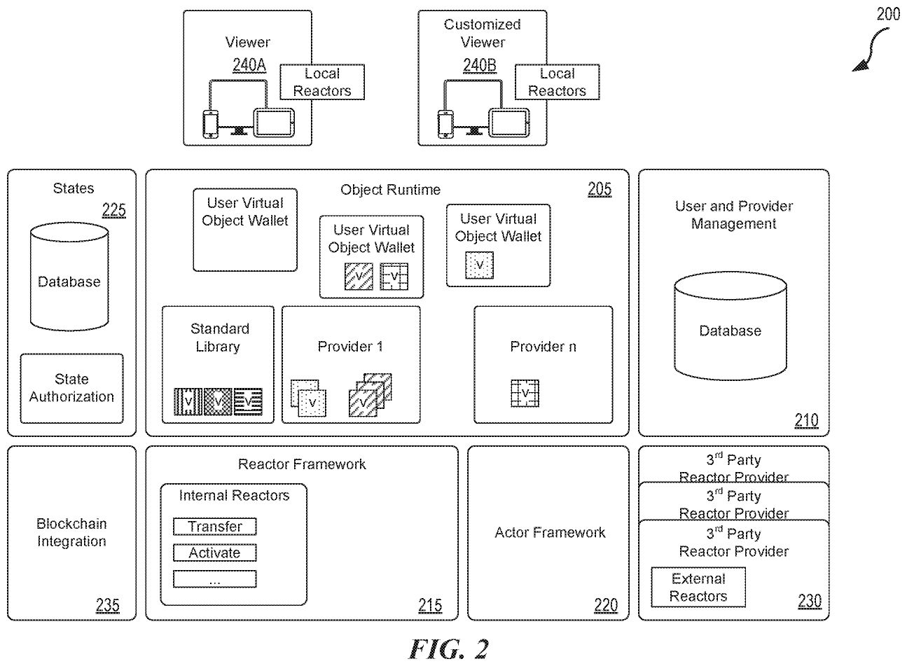

FIG. 2 illustrates an example of various components of virtual object platform 130, according to one or more embodiments of the present technology. As illustrated in FIG. 2, virtual object platform 130 can include object runtime 205, a user and provider management module 210, reactor framework 215, actor framework 220, states module 225, third-party reactor provider interfaces 230, blockchain integration module 235, viewers 240A-240B, and/or other components. Each of these components, modules, frameworks, interfaces, viewers, etc. can be embodied as special-purpose hardware (e.g., one or more ASICS, PLDs, FPGAs, or the like), or as programmable circuitry (e.g., one or more microprocessors, microcontrollers, or the like), appropriately programmed with software and/or firmware, or as a combination of special purpose hardware and programmable circuitry. Other embodiments of the present technology may include some, all, or none of these modules and components, along with other modules, applications, and/or components. Still yet, some embodiments may incorporate two or more of these modules and components into a single module, and/or may associate a portion of the functionality of one or more of these modules with a different module. For example, in one embodiment, reactor framework 215 and actor framework 220 can be combined into a single module.

Virtual object platform 130 can include memory (not shown) that can be any device, mechanism, or populated data structure used for storing information. In accordance with some embodiments of the present technology, the memory can encompass any type of, but is not limited to, volatile memory, nonvolatile memory and dynamic memory. For example, the memory can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, the memory may include one or more disk drives, flash drives, databases, tables, files, local cache memories, processor cache memories, relational databases, flat databases, and/or the like. In addition, those of ordinary skill in the art will appreciate many additional devices and techniques for storing information that can be used as memory.

The memory may be used to store instructions for running one or more applications, viewers, or modules on a processor(s) (also not shown). For example, memory could be used in one or more embodiments to house all or some of the instructions needed to execute the functionality of object runtime 205, a user and provider management module, 210, reactor framework 215, actor framework 220, states module 225, third-party reactor provider interfaces 230, blockchain integration module 235, viewers 240A-240B, and/or other components.

Object runtime 205 within platform 130 maintains and controls the creation, existence, and destruction of the virtual objects. Object runtime 205 can include a standard library that provides a core or root template for a number of standard virtual objects. These templates of standard virtual objects can be used as a basis for a registered provider to create new virtual objects. For example, the templates can include models for selected objects or object categories, such as consumer products, food, beverages, stickers, trading cards, pieces of art, artistic performances, digital representations of real world objects (e.g., gold bar, fish, etc.), and the like. Once created, the virtual objects can be distributed to users, such as by being added to a user's digital account, which may be referred to as a digital wallet or garage).

User and provider management module 210 within platform 130 can track registered provider information and allow new creators to register with the platform. For example, in accordance with some embodiments, a creator can register with platform 130 using a software application or portal. The registration process can include the collection of a variety of information such as, but not limited to, name, address, telephone numbers, credit card information, and the like. Some embodiments of platform 130 may have various subscription tiers for monetizing virtual objects and/or the provider registration process or tools. For example, the tiers may provide an initial number of virtual objects the registered provider can create on a daily, weekly, monthly or yearly basis. As another example, registered objects may be stored free for one year and that storage can be extended for additional years for a yearly fee. Unique “names” can only be registered once and can be reserved for a fee like a domain registry. Paid names may come with free storage as long as you pay for the name. User and provider management module 210 can track the criteria set forth by the tier selected by the registered provider.

Reactor framework 215 within virtual object platform 130 governs the change of various states of the virtual objects in response to interactions (e.g., viewing, manipulating, exchanging, etc.) with the virtual objects after receipt by the registered users. The states of virtual objects can include activation and ownership in some embodiments. In other embodiments, more complex states and state changes may be governed by reactor framework 215 based on software code associated with a virtual object, evolutionary rules (e.g., based on virtual object classification), or rules set by the registered provider during creation of the virtual object. In one example, virtual objects can represent virtual plants, and reactor framework 215 can set the rules for how often the virtual plants should be watered and how the plants will virtually grow or otherwise react in response.

Actor framework 220 within platform 130 can govern the change of various states of the virtual objects in response to external events. Examples of external events can include time of day, geographic location, event status, environmental conditions, weather, product prices, stock prices, and the like. The actor framework 220 can monitor for those events and alter or otherwise control the state of the virtual objects, or perform actions on the virtual objects, according to various rules as a function of the external events.

States module 225 within platform 130 maintains the state of the virtual objects. Examples of states can include ownership, aesthetic or visual properties (e.g., color, patterns, etc.), audio properties (e.g., sounds), virtual health or status, location, expiration dates, number of interactions, number of transfers, and others. For example, a virtual object with a designated location state may only be accessible from a computing device within a range of the designated location. The virtual object may have inherent states that include inactive, activated (i.e., for virtual objects associated with software code, the activation triggers the execution of the associated code) or in reaction (i.e., being currently modified). In addition, creators of the virtual objects may add (e.g., during creation or after distribution) additional states for each virtual object created.

The states of a virtual object can also include states (i.e., characteristics) of the corresponding real-world counterpart of the virtual object. For example, a virtual beer may have states that include a temperature state that can indicate if the virtual object currently has a cold state and a warm state. Similarly, a virtual puppy could include states representing health, hunger, age, energy level, mood, and the like. States module 225 keeps current track of each state of the virtual object. Reactor framework 215 can allow for submission of code from various third-parties that govern the state change of their virtual objects via third-party reactor provider interfaces 230.

Blockchain integration module 235 within platform 130 allows ownership changes of the virtual objects to be tracked and recorded using a blockchain system. Viewers 240A-240B (internal and external to platform 130) allow registered providers and users to view the virtual objects that have been created. In some embodiments, viewers 240A-240B can be html based websites, mobile applications, voice interfaces, virtual realities, augmented realities, and the like. These viewers can also be created by various third-parties using various APIs for interfacing with the object runtime 205.

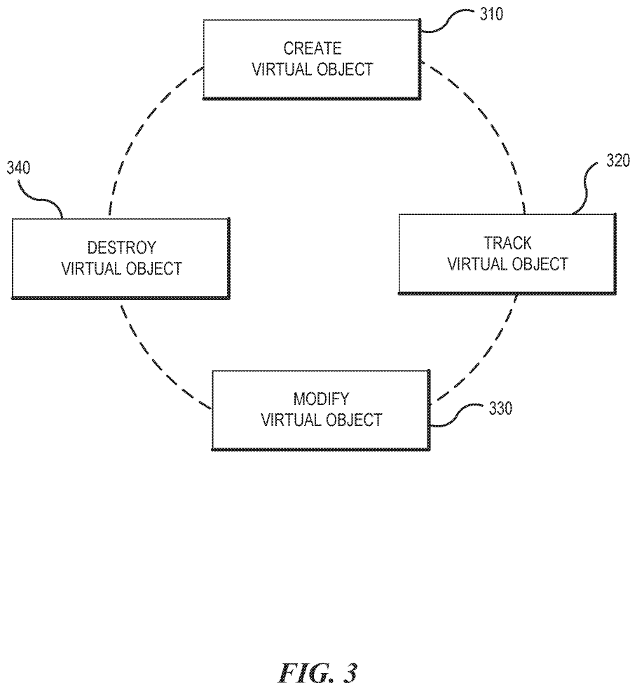

FIG. 3 illustrates an example of a life cycle of a virtual object according to one or more embodiments of the present technology. As illustrated in FIG. 3, each unique virtual object is created during creation operation 310 such that the virtual object is not identical to any other virtual object, and the virtual objects are not reproducible. For example, in some embodiments, the virtual objects may be associated with a unique identifier and registered with the blockchain system to creates unique virtual objects that cannot be duplicated (as the authenticity can be verified via the transaction logs of the blockchain system).

Once the virtual objects are created, platform 130 can be used to distribute the virtual objects to various registered users. For example, the virtual objects may be distributed to registered user by directly adding the virtual object to a digital wallet associated with the registered user. As another example, the virtual objects can be distributed to non-registered users using a variety of channels, such as but not limited to, text, e-mail, website link, or other electronic messaging. In order to access the virtual objects, the non-registered users may be directed to register and/or use a viewer that allows non-registered or registered users to interact with selected virtual objects.

As the virtual objects are distributed (e.g., owners are assigned and notified), the platform tracks the ownership of each and every one of the virtual objects (e.g., using blockchain system 140) using tracking operation 320. Over time, the owners of the virtual object may modify the state of the object using modifying operation 330. This can happen, for example, by combining multiple objects with different properties (e.g., using reactor framework 215). In other embodiments, the virtual object may automatically modify itself over time or in response to various inputs (or lack thereof).

Many virtual objects may continue to exist indefinitely, while others may expire under certain conditions. For example, some virtual objects may only exist for a limited time. As another example, some virtual objects may expire once they are combined with other virtual objects. Some virtual objects may require certain interactions from a user in order to continue to exist. For example, if the virtual object is a virtual plant, the virtual plant may need virtual water and virtual sunshine to continue to exist. Once the expiration of a virtual object has occurred (e.g., by consumption, combination, date, neglect, etc.), destruction operation 340 can deactivate the virtual object and the blockchain can be updated accordingly.

For example, in some embodiments destruction operation 340 can set a state of the virtual object to invalid. An indicator (e.g., an icon) associated with the virtual object may be removed from or left in the user's inventory in response to expiration of a virtual object. When the virtual object is removed from the user inventory, some embodiments can move the virtual object into a “discard pile” (or holding bin) that could be inaccessible to the user. In some embodiments, the virtual object can be physically deleted or removed from the virtual object platform 130 and/or blockchain system entirely. For example, on the blockchain system, removal could include moving the entries to a controlled address for discarded/disabled virtual objects, or revocation from the blockchain entirely.

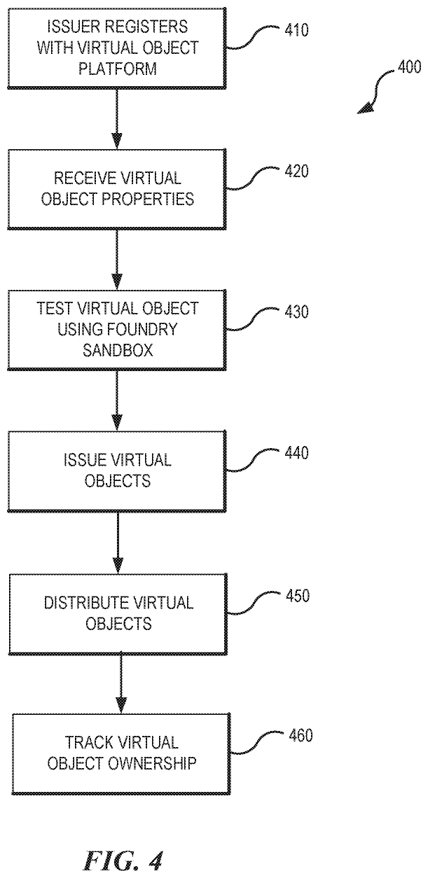

FIG. 4 is a flowchart illustrating a set of operations 400 for operating a virtual object platform 130 according to one or more embodiments of the present technology. As illustrated in FIG. 4, the creation of a virtual object may require a creator to register with the virtual object platform 130 during registration operation 410. Once registered, the creator can input a name for the object. The virtual object platform 130 may check to see if that name is available. The names may be unique identifiers so that two non- affiliated objects do not have the same name at the same time. If someone else already owns that name for an object, the creator can be prompted to try again until a requested name is verified as unique.

The standard library within object runtime 205 of virtual object platform 130 may provide a variety of building templates for use by a creator (i.e., a registered provider) that aids in setting the virtual object properties during receiving operation 420. The creator can choose a template for the desire to virtual object as a base to build upon, or the creator can create a new object template from scratch. A selected template will be displayed showing a variety of virtual object attributes that the creator can modify. For example, these attributes can include a number of objects to be created, pictures or videos to associate with the object, redemption values, a social tag with degrees of separation indicating that the object is redeemable only after it's been given out to at least one degree of separation, expiration, actions, and the like.

The operations 400 can have a testing operation 430, wherein the virtual object may be tested by the registered provider via, as an example, integrated simulation viewers within platform 130. For example, the creator can go into a test simulation, referred to as the “sandbox” and test the virtual object. In one embodiment, a test scenario can be run or otherwise performed, and three or more simulated user accounts can be set up with simulated viewers—one for the original owner of the virtual object, one for a simulated friend (SF), and one for a simulated redemption vendor (RV). This test scenario may be a default setting for a new sandbox, but creator may be able to add or subtract as many simulated accounts of various types as they like.

For example, the creator can view the virtual object in its default state as an initial user, trigger various actions and confirm operation or behavior of the virtual object, and identify any bugs or anomalous behaviors. The creator can also simulate redeeming the virtual object by giving it to the RV, and confirm whether the virtual object behaves as expected. The creator can simulate giving the virtual object to the SF account, and confirm that the virtual object has transferred into the SF's account or inventory, and that the virtual object disappears from the original account, thereby representing a successful ownership change. The creator can also simulate having the SF give the virtual object to the RV and confirm that the virtual object will disappear from the SF account, appearing in the RV account, and then change state in the RV account as an “empty” picture. A simulated “pool” counter can be used to keep an accounting relating to the created virtual objects, which can be used to indicate corresponding changes in the RV account. Using the simulation results, the creator can go back to the virtual objects' meta data and update/change/modify anything, add new code, etc., and continue to go back and forth to the sandbox until the interactions are working as the creator desires.

During issuance operation 440, the platform can issue the virtual objects by creating individual registry entries in blockchain system 140. Each of the registry entries can be associated with an initial state of the virtual object and possibly with a piece of software code. The initial state could, for example, be set by a class associated with the virtual object selected by the registered provider while creating the virtual object, or some other default state (e.g., inactive). The set number of virtual objects can then be distributed using distribution operation 450 using a variety of electronic channels such as, but not limited to, digital wallets, e-mail, text messages, items within games or other interactive computer program, and others. The virtual objects may initially be distributed to a business or individuals that can trade, sell, modify, or exchange the virtual objects. Using tracking operation 460, the object ownership and state can be tracked using blockchain system 140.

In accordance with various embodiments, the entry on the blockchain acts as a reference to the unique identifier in virtual object platform 130. Any software code and/or logic related to the virtual object could be stored directly on the block chain. In some embodiments, the blockchain entry may include a reference (e.g., a url, index, identifier, etc.) that can be used to retrieve the software code from a database. For example, the reference may identify a virtual object class along with a particular instance that is being retrieved from virtual object platform 130. The virtual object platform can then retrieve the blockchain index/identifier and relate it to the unique object identifier in the virtual object platform to access the software related to the virtual object.

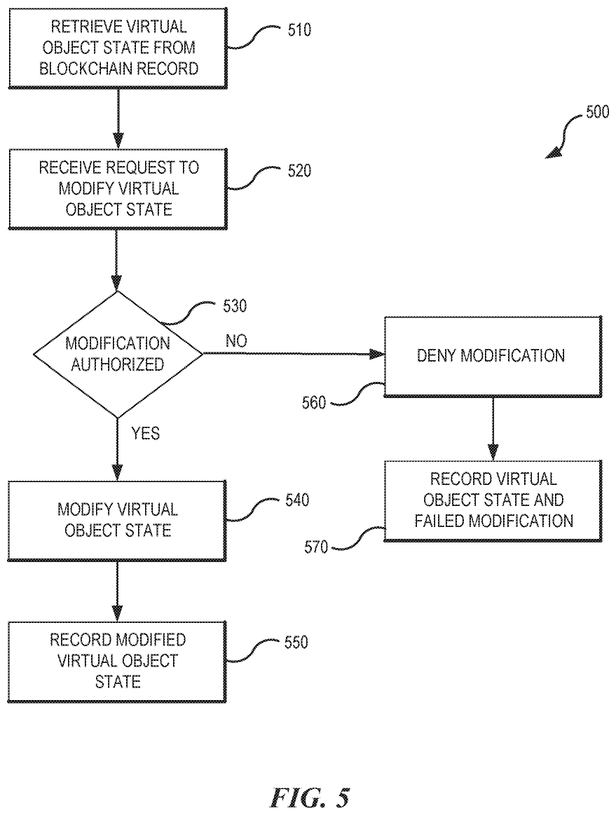

FIG. 5 is a flowchart illustrating a set of operations 500 for tracking a state of a virtual object according to various embodiments of the present technology. As shown in FIG. 5, retrieval operation 510 retrieves state information from the blockchain record. Retrieval operation 510 may be performed by an end-user's software application and/or a reactor framework 215. For example, the retrieved state information can include one or more identifiers that can be for the object class itself (e.g., a beer), and the individual instance identifiers for the actual objects (e.g., beer #7). With this information, the virtual object platform can identify an return the object's current state. If this information is encoded on the blockchain, then the particular state information could be returned directly from the block chain system.

The end-user's software application may request that the virtual object be modified. For example, the application may request that the virtual beer have a temperature state changed from warm to cold. This request may be generated in response to a direct action from the registered user or from the software application processing various evolutionary rules (e.g., event driven rules) governing the virtual object. The modifications can then be sent to virtual object platform 130. During receiving operation 520, the request to modify the state information of the virtual object is received at platform 130.

Determination operation 530 determines if the modification is authorized. For example, only a current owner of the virtual object may modify the state. As another example, there may be various evolutionary rules that dictate how the virtual object should respond over time or to various events. When determination operation 530 determines that a modification is authorized, determination operation 530 branches to modification operation 540 to modify the state of the virtual object. The modified state information is recorded with the blockchain system with recordation operation 550. When determination operation 530 determines that a modification is not authorized, determination operation 530 branches to denial operation 560 where the modification is denied and recordation operation 570 records the virtual object state and failed modification with the blockchain system.

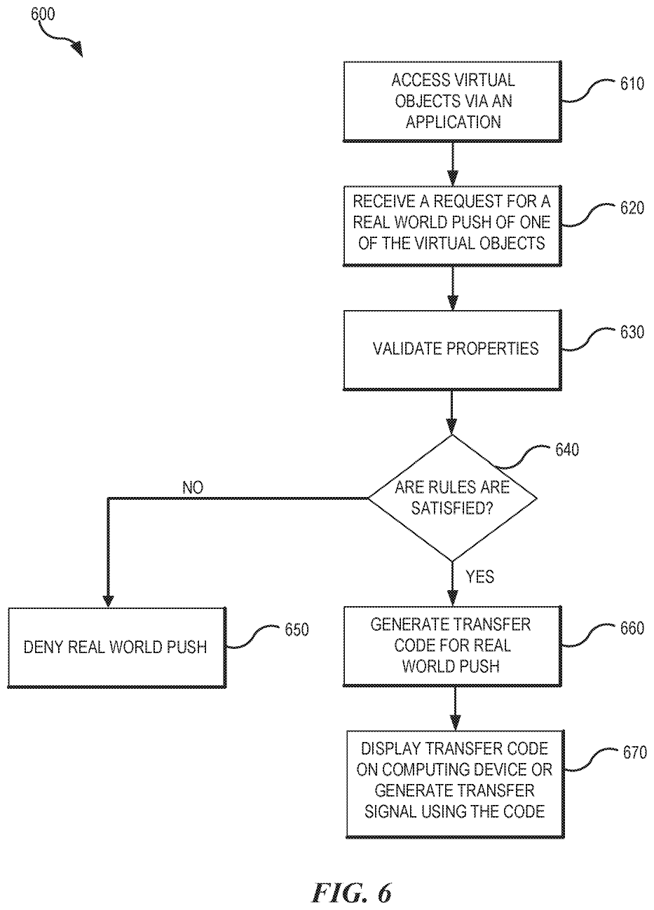

FIG. 6 is a flowchart illustrating a set of operations 600 for redeeming or otherwise exchanging a virtual object for a real-world object in accordance with some embodiments of the present technology. As illustrated in FIG. 6, a registered user of an application running on a computing device (e.g., a mobile phone or tablet) can submit a request to access virtual objects associated with their account (i.e., a registered user's inventory in a digital wallet). During access operation 610, the application can retrieve one or more of the virtual objects from platform 130 and present them to the user. During request operation 620, the application receives a request form the user, via the application, for a real world push of one of the virtual objects, such as a request to redeem a virtual object for a real-world item (i.e., money or goods) or a service.

Validation operation 630 can validate the properties of the virtual object selected for the real-world push. For example, some objects may only be exchangeable for real-world objects within certain geographical locations. Once the properties of the virtual object are validated, determination operation 640 determines if one or more rules are satisfied. If any of the rules are not satisfied, then determination operation 640 branches to denial operation 650 where the real-world push is denied. If determination operation 640 determines that the rules are satisfied, then determination operation 640 branches to generation operation 660 where a transfer code (e.g., a machine readable code, a barcode, a QR code) or signal (e.g., using a near field communication transceiver, Bluetooth component, or other transmitter) can be generated, displayed, and/or transmitted during display operation 670.

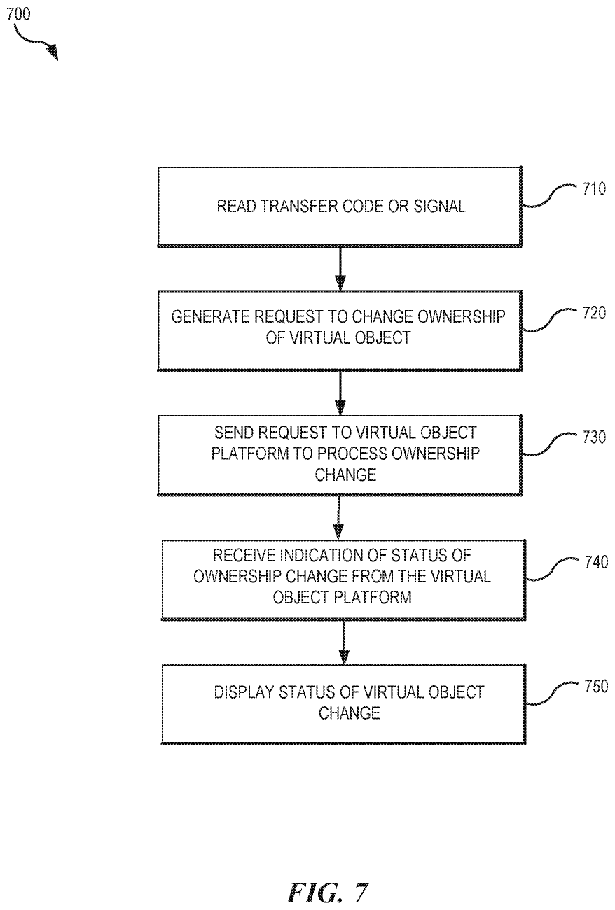

FIG. 7 is a flowchart illustrating a set of operations for changing ownership of a virtual object in accordance with some embodiments of the present technology. As illustrated in FIG. 7, a transfer code (e.g., a QR code, a barcode, machine-readable code, an encrypted signal, etc.) hosted on an originating device can be scanned, read, or detected by a receiving device during reading operation 710. Once the transfer code has been read or entered, an application running on the receiving device can generate a request to change ownership of the virtual object during generation operation 720.

For example, the machine readable code may be used to access properties (e.g., a unique identifier) of the virtual object that can be used by the application to create a request to change ownership of the virtual object. As another example, the transfer code may be used to access a request (e.g., stored in a database) to change the ownership of the virtual object that was previously created. Still yet, as another example, if a registered user has a coupon for a product that they wish to acquire from a billboard or QR code, the identifier on the billboard or the QR code could refer to a virtual object that has attributes such as public and acquirable (or that there are available objects in this state).

The receiving device can then send the request to the virtual object platform for processing during transfer operation 730. The virtual object platform can determine if the conditions are met for the transfer. For example, in the coupon example being acquired by from the billboard, the platform may determine if there are instances of the virtual object identified by the billboard or QR code that are public and acquirable before the transfer would occur correctly. Of course other conditions may be present or required for transfer. For example, some virtual objects can only be transferred a limited number of times, never to the same user twice, when the user is in a specific geographical location, and the like. The virtual object platform can return a confirmation during receiving operation 740. The confirmation may indicate that the ownership change was successful, not successful, still pending, or requires more information/authentication to be completed. The confirmation can then be displayed during display operation 750.

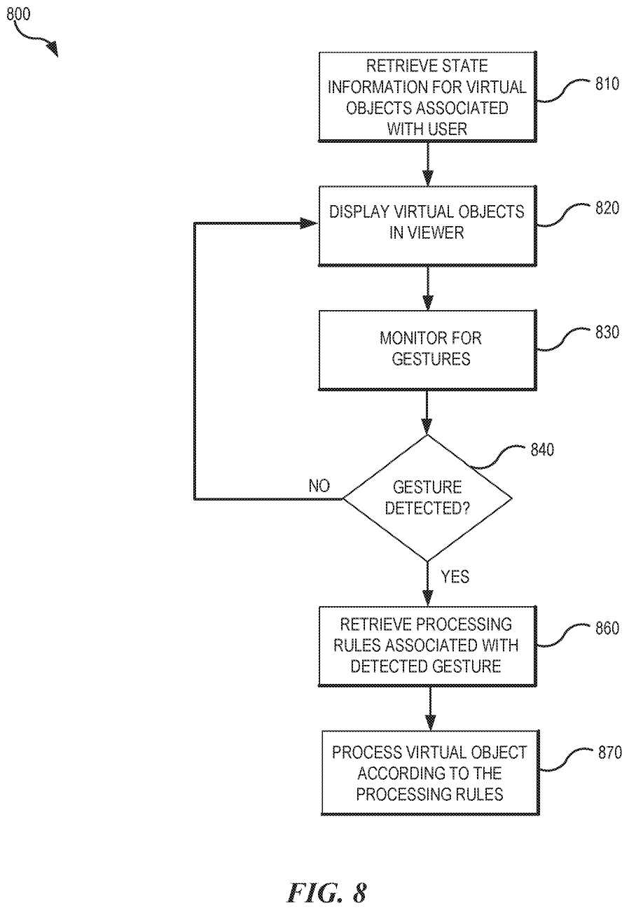

FIG. 8 is a flowchart illustrating set of operations 800 for processing gestures detected within a viewer in accordance with various embodiments of the present technology. As illustrated in FIG. 8, retrieval operation 810 can access the blockchain system and determine the current state information for virtual objects associated with the registered user. The virtual objects can be displayed via a viewer on a computing device of the registered user during display operation 820. Monitoring operation 830 monitors for various user interactions and gestures via the computing device.

For example, a preset cursor movement or detected touch motion quickly moving from within a viewer window to a side can be used as a gesture to cause a change ownership. Accordingly, a registered user can “swipe to the side” on the viewer to move the selected virtual object to the registered user's inventory to the inventory of another selected user. As another example, a drag down or swipe can be used to acquire a virtual object. In addition to various types of gestures, relationships between virtual objects and where that virtual object exists (e.g., container, geo-position, etc.) can be established. For example, users can drop virtual objects at a location and pick them up again, using geolocation. Some virtual objects may be able to move location on its own (e.g., a pet). Users may be able to pick up a virtual object from a live stream (e.g., television, billboard, etc.) based on location and timestamp or from audio signature. A user may be able to pick up a virtual object from a website, a virtual reality environment, an augmented reality environment, or the like. Still yet, in some embodiments, users may be able to combine virtual objects to form a new object. Virtual objects may act as a bearer bond for commodity exchange of linked goods.

During determination operation 840 a determination is made as to whether a gesture has been detected. If no gesture has been detected, then determination operation 840 branches to display operation 820. If determination operation 840 determines that a gesture has been made, the determination operation 840 branches to rule operation 860 where processing rules associated with the detected gesture are retrieved (e.g., from local memory, from a cloud-based data store, from virtual object platform 130, etc.). The virtual object is then processed in accordance with the processing rules.

In addition to processing currently owned virtual objects as described in FIG. 8, virtual objects may also be obtained via gestures on a phone (i.e., holding up a phone at a concert to “catch” virtual objects, or scooping a virtual object off a table in augmented reality, or swiping a virtual object off a billboard or television commercial). Some embodiments allow for exchange of virtual objects by flicking them from one device to another. Some embodiments allow the system or user the ability to put bitcoins into a virtual object and, as a result, the ability for the virtual object to hold bitcoins and intelligently spend them as part of their mission. Virtual objects created by the system may be event-driven from real-world actions and traceable/social.

In some embodiments, the events that govern the evolution or state change of a virtual object may be external to the system. In order to detect the events, some embodiments use a feature referred to as a “listener” to monitor data feeds (e.g., stock quotes, news feeds, or other data feeds etc.) or other external inputs (e.g., user taps on a touchscreen or other interaction gestures with the user's smart phone) for each virtual object to determine if the events have occurred. The listener can be configured to monitor various attributes depending on the conditions desired to update the virtual object. An example of an event-driven virtual object is a coupon that is provided to attendees of a basketball game, where the coupon initially contains no redeemable value. In the event that the basketball team scores a certain number of points during the game, the virtual object can change state to become redeemable (e.g., a coupon for free tacos). The listener can monitor one or more data feeds that report the score of the basketball game. Upon determining that the needed score has been reached, the listener notifies the virtual object platform to push the state update to the virtual coupons that have been issued to the user.

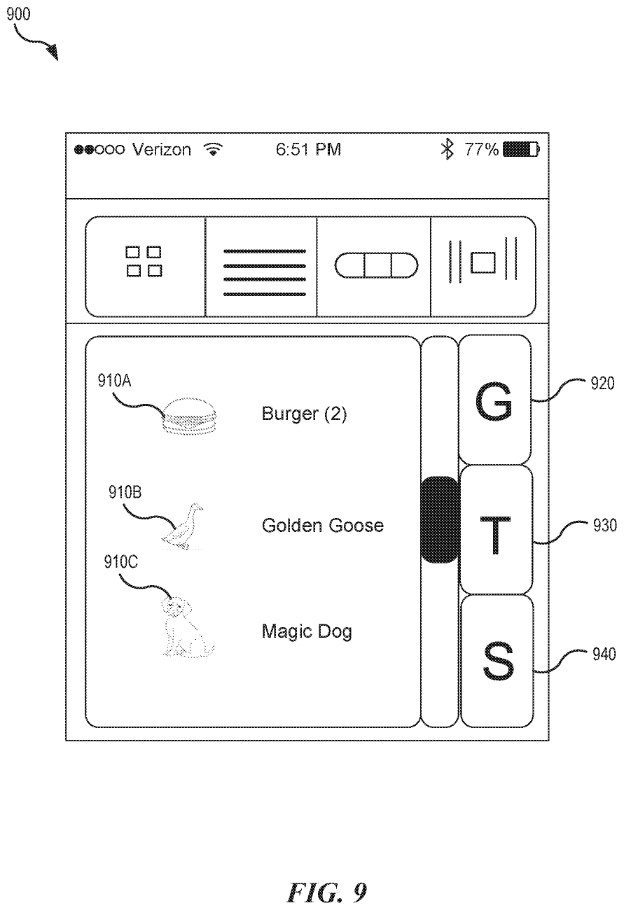

FIG. 9 is an example of a viewer allowing a user to interact with multiple virtual objects in accordance with one or more embodiments of the present technology. Virtual objects 910A-910E can be displayed in viewer 900. The rules for the evolution and modification of virtual objects 910A-910C can be set by the registered provider and are limited substantially only by the registered provider's imagination.

For example, virtual object burger 910A may allow the registered user to redeem the virtual object for real burger, or as an offer to others. The virtual object burger 910A may also allow a registered user the ability to add a customized burger recipe to the virtual object burger 910A with the registered user's name associated with virtual object burger 910A, and pass virtual object burger 910A on to others, creating a burger recipe chain. Still yet, if a registered user “plants” virtual object burger 910A in a magic pot, virtual object burger 910A may grow into a burger tree and flower new burgers on branches at regular intervals. Selling burger tree may be valuable, but the tree eventually may slow production and shrivel up over time.

Virtual object goose 910B may be designed to lay golden lattes once per week. The lattes can then show up in the registered user's inventory and can be redeemed at a coffee shop for a latte. However, goose 910B may die if not fed and/or after creation of a set number of lattes (e.g., 10). As a result, the value of goose 910B diminishes over time. Magic dog virtual object 910C can be activated by the registered user. In response, the magic dog 910C can wag his tail and do a few tricks. If the registered user drags a burger 910A on the magic dog 910C, magic dog 910 will eat the burger. If magic dog 910 gets a set number (e.g., 5) of burgers, magic dog 910C can transform from a dog into a “Fairy God Dog” and grant the registered user one of several wishes—e.g., prizes, redeemable products from sponsors, etc. A registered user may feed magic dog 910C five burgers and then sell magic dog 910C to another user based on speculative value of wishes.

When a registered user drags one of the virtual objects into gift bin 920, the viewer may allow the registered user to identify a recipient. The virtual object may be removed the viewer upon a final indication from the user to transfer ownership of the virtual object to the recipient. In some embodiments, the transfer may not be completed until the recipient accepts the virtual object. In those embodiments, the registered user's viewer may change the visualization of the virtual object to show a transfer is pending.

When a registered user drags one of the virtual objects into trade bin 930, the viewer may allow the registered user to identify a trading partner or transaction. When the trading partner adds items to their trading bin, the swap or trade may occur. When a registered user drags one of the virtual objects into the sell bin 940, the viewer may allow the registered user to specify an optional minimum price. If a bidder makes an acceptable offer, then the transfer of ownership will proceed.

Other examples of virtual objects (not shown) can include the following:
1) A magic key that opens secrets and tips on gamer team sites. The magic key can be pushed into real world and used for access to backstage passes at League of Legends finals.
2) A beer virtual object can be gifted and consumed virtually. If the registered user toasts with a friend who accepts, and who also has a beer, the virtual beers will animate, clink together. If you push beer into real world, the beer can be redeemed for a real beer from a participating vendor.
3) A trophy virtual object can be customized by the registered user and then awarded to someone. The registered user can prevent the recipient from giving trophy to anyone else for some period. Some items can't be re-gifted right away, or ever depending on creator's rules. As another example, trophy may be used by the registered user to thank someone for something and then have the recipient thank someone else and pass it on, creating a string of public honorees and heartfelt thanks.
4) A positive man virtual object can be designed to say something positive and life affirming to the registered user every day for a year. The positive man virtual object can be “turned” into a negative man if the registered user is not “kind” to him by, for example, saying nice words back.
5) X-ray specs virtual object can allow the registered user to see secret videos and special tips on select sites (e.g., tips to gamers).
6) A rabbit virtual object may allow the registered user to add a sentence to the rabbit's story and pass it on. When the registered user activates the rabbit, the rabbit can tell the story as collected so far and welcome the new recipient to add another line. If the current owner has already added a line, platform 130 will not let the registered user add another and the registered user will need to pass the rabbit on. If story is good, someone can mount it on the wall. If the story is not good, a recipient can kill the rabbit.
7) A piggy bank virtual object may allow a registered user to put money in the piggy bank and then pass the piggy bank on to someone else. The new owner can put money in as well and forward pig. When piggy bank reaches its goal, value transfers to the charity and fireworks can go off in everyone's viewer who donated.
8) A mystery gift virtual object may change a secret gift inside periodically (e.g., every day). If a registered user chooses to open the mystery gift one day, the mystery gift will be different than before. Gifts could range in value from 5 to 500 dollars and be randomly inserted every day. Registered users will have to decide wither to risk opening the mystery gift or decide whether it is better to trade the mystery gift for what someone else will offer.

In accordance with various embodiments, the virtual object can be asset backed. Asset backed virtual objects may be traded on exchange. As another example, the asset backed virtual object may be a graphical representation of bitcoin denominations (in U.S. dollars, etc.) and transferability across wallets. Various embodiments of the virtual objects may also have applications in multi-level marketing. For example, sharing content via a virtual object can create an ownership chain. As the distributed virtual objects are consumed, traded, and/or shared, benefits to those higher up the ownership level can be distributed (e.g., a tenth of a cent for every time someone below them watches a link or video associated with the virtual object).

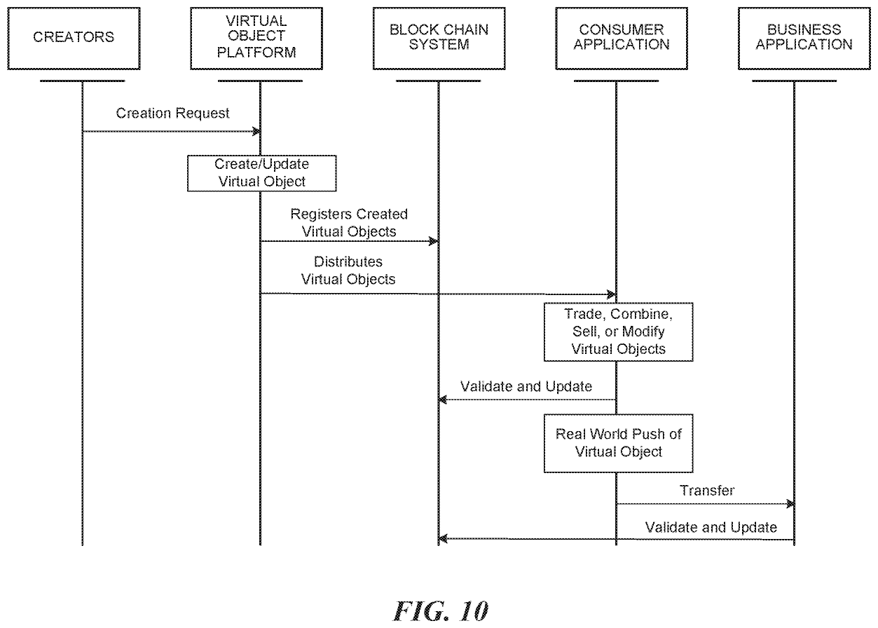

FIG. 10 is a sequence diagram illustrating an example of the data flow between various components of a virtual object framework, according to various embodiments of the present technology. As illustrated in FIG. 10, creators can generate a request to create a specified number of virtual objects that will be created and tracked by the virtual object platform. Once the request is submitted to the virtual object platform, the specified number of virtual objects can be created and then registered with a block chain system for tracking ownership. The virtual objects are then distributed and can be accessed by the owner via a consumer application. Using the consumer application, the owner of one of the virtual objects, can trade, combine, sell, or modify the virtual object. These properties are updated and any ownership change is validated and updated using the block chain system. In some embodiments, the owner may use the consumer application to generate a real world push which can be accessed by a business application that will validate and update ownership via the block chain system.

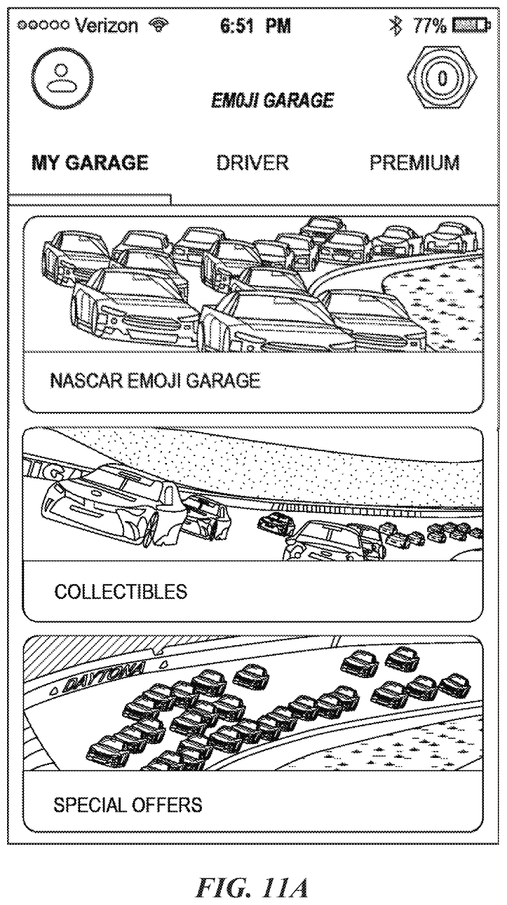

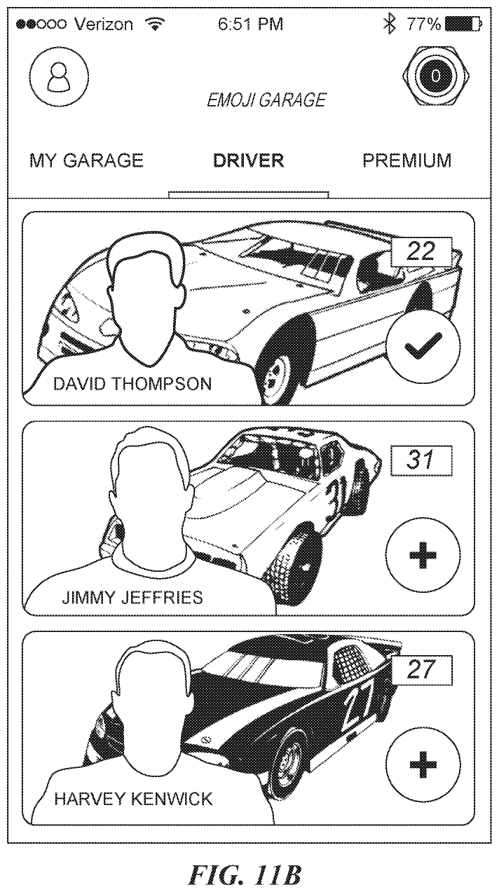

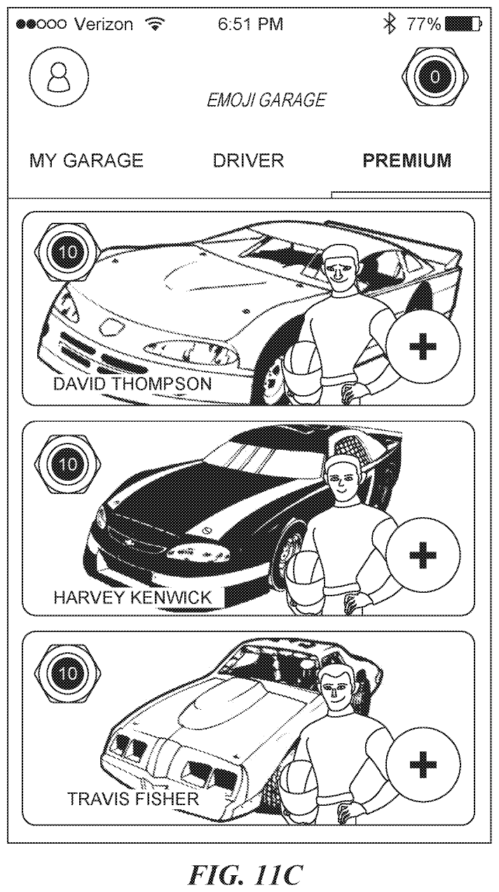

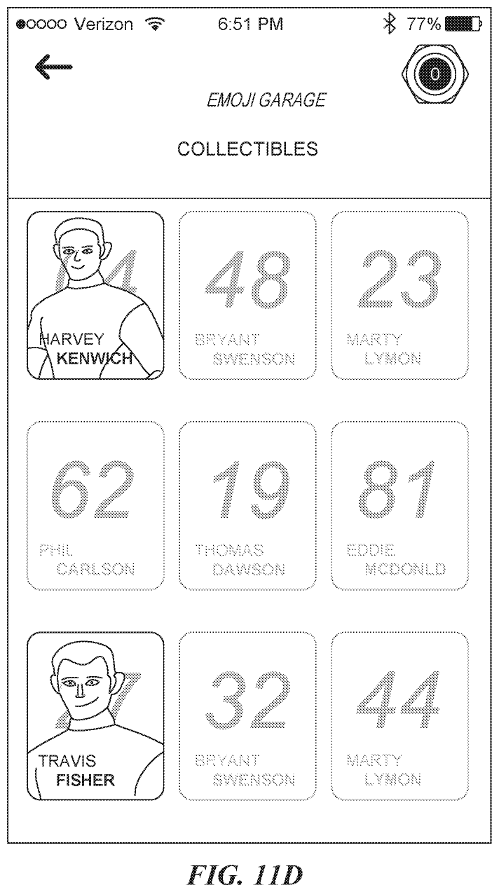

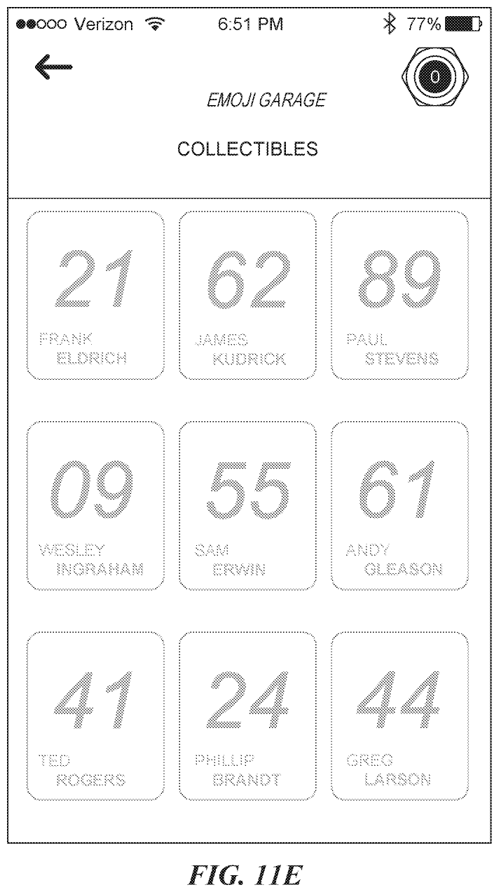

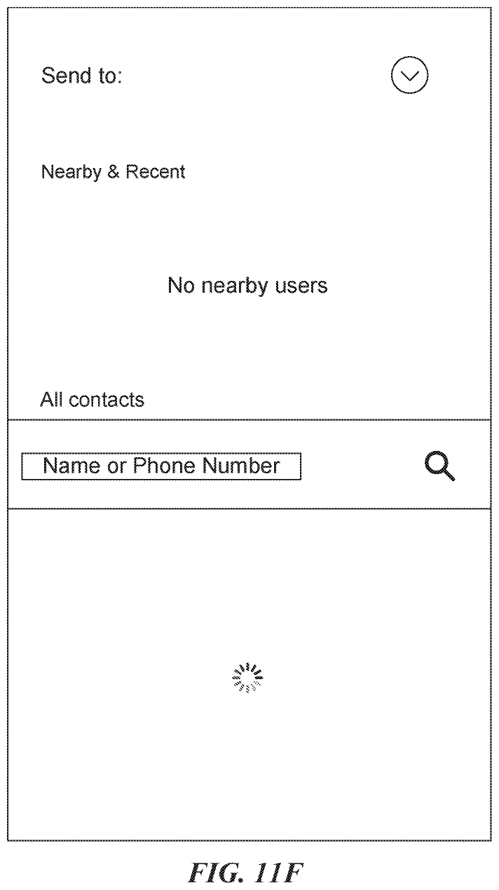

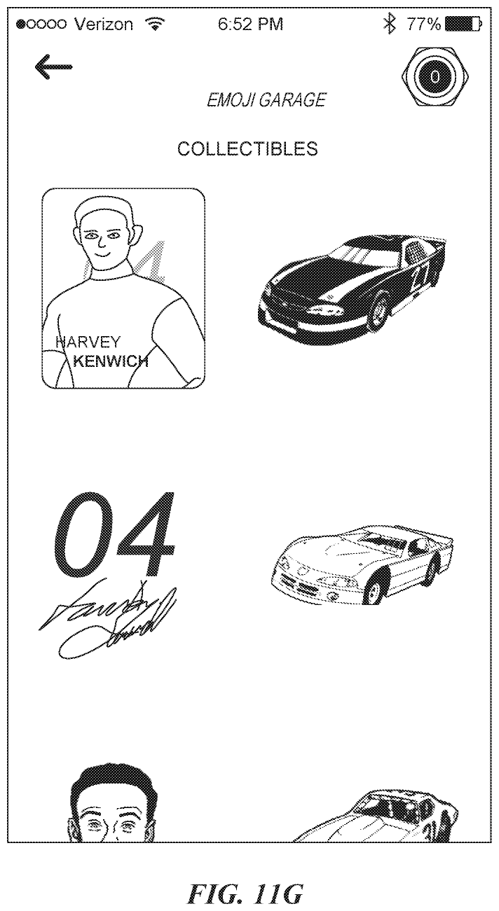

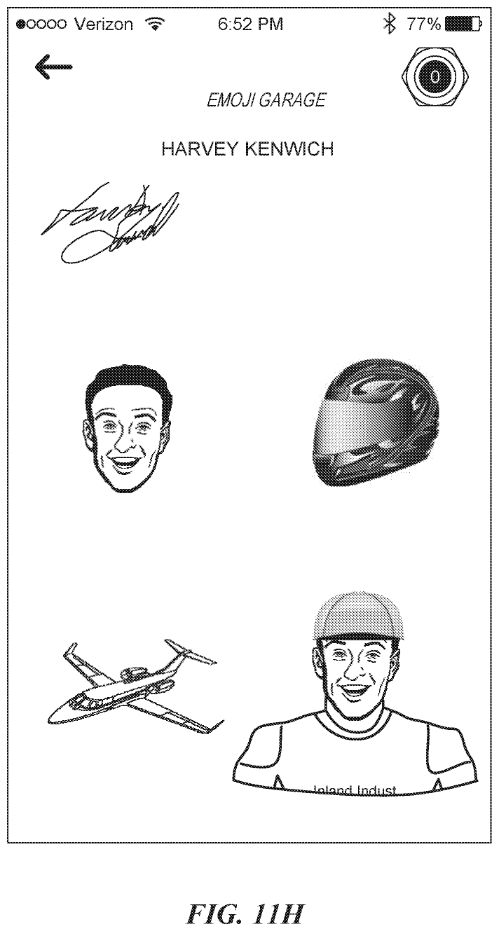

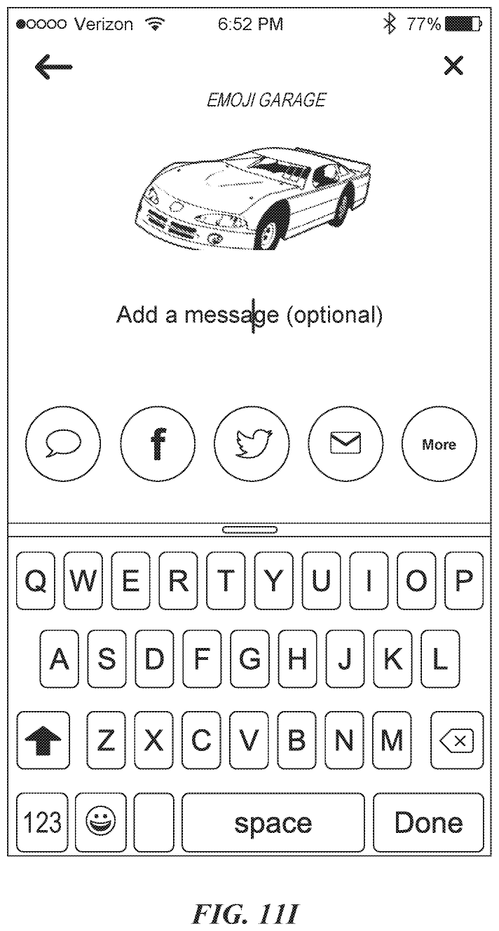

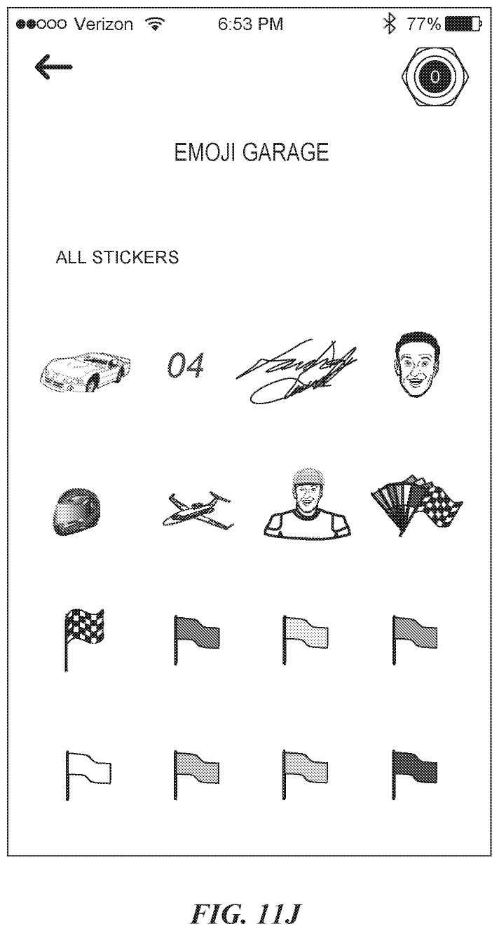

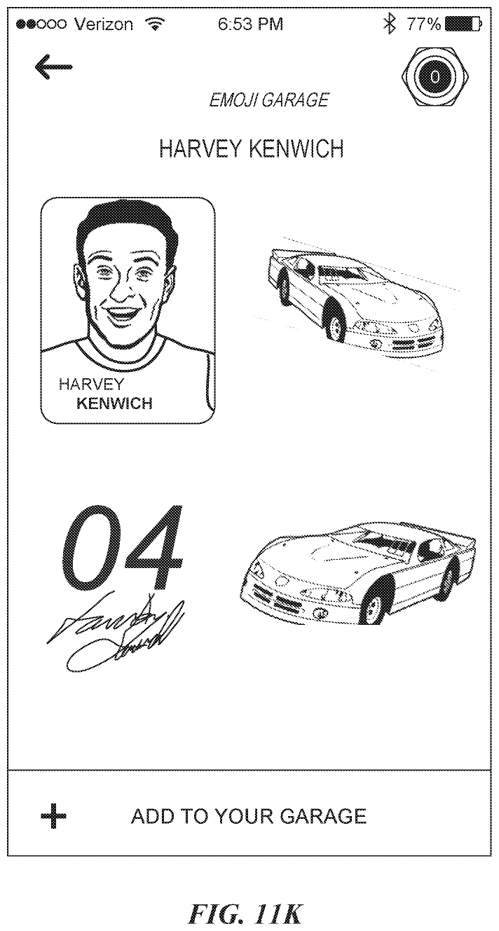

FIGS. 11A-11K are screen shots of an example of unique virtual objects, shown as collectable trading cards created and tracked in accordance with one or more embodiments of the present technology. FIG. 11A illustrates an example of a screenshot of an application that allows for the collection and exchange of trading cards. The trading cards are unique digital objects created by a creator, and ownership of each digital object is tracked and recorded as they are gathered and transferred from owner to owner. For example, FIGS. 11D-11E show the current trading cards that have been collected by the user. By selecting any one of the cards, the application will allow the user to transfer ownership to another user (e.g., using an interface such as the one shown in 11F). The ownership transfer is recorded and tracked. One or more of the ownership transfers may be associated with an exchange, such as a sale, a simulated sale, a credit exchange, a chattel or other trade, or a gift transfer. While items such as the trading cards may have a limited number, other items such as the emojis and stickers shown in 11J may or may not have a limited number of uses or exchanges.

### Exemplary Computer System Overview

Aspects and implementations of the virtual object platform 130 of the disclosure have been described in the general context of various steps and operations. A variety of these steps and operations may be performed by hardware components or may be embodied in computer-executable instructions, which may be used to cause a general- purpose or special-purpose processor (e.g., in a computer, server, or other computing device) programmed with the instructions to perform the steps or operations. For example, the steps or operations may be performed by a combination of hardware, software, and/or firmware.

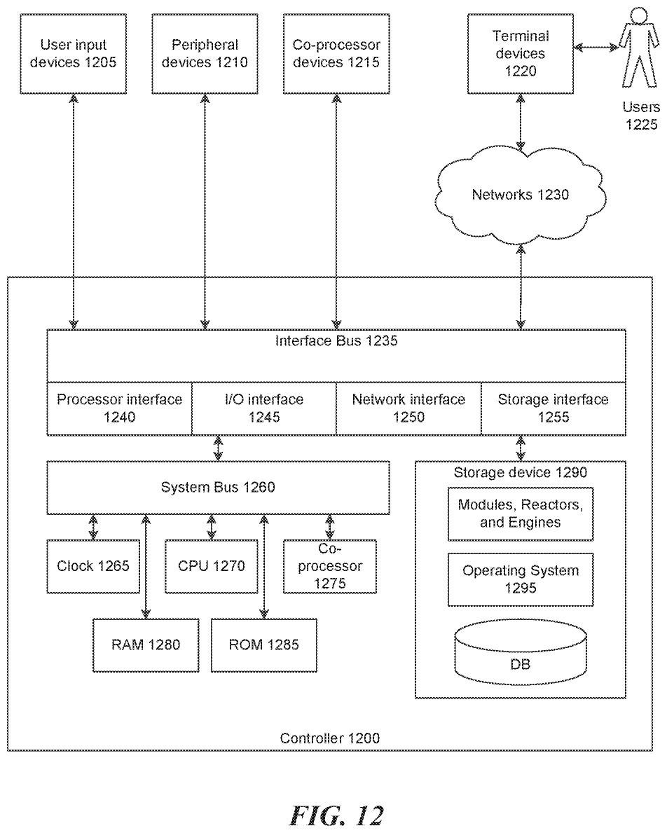

FIG. 12 is a block diagram illustrating an example machine representing the computer systemization of the virtual object platform 130. The virtual object controller 1200 may be in communication with entities including one or more users 1225, terminal devices 1220 (e.g., devices 110A-110N), user input devices 1205, peripheral devices 1210, optional co-processor device(s) 1215 (e.g., cryptographic processor devices), and networks 1230 (e.g., communications network 120 in FIG. 1). Users may engage with the controller 1200 via terminal devices 1220 over networks 1230.

Computers may employ central processing unit (CPU) or processor to process information. Processors may include programmable general-purpose or special- purpose microprocessors, programmable controllers, application-specific integrated circuits (ASICs), programmable logic devices (PLDs), embedded components, a combination of such devices, and the like. Processors execute program components in response to user and/or system-generated requests. One or more of these components may be implemented in software, hardware or both hardware and software. Processors pass instructions (e.g., operational and data instructions) to enable various operations.

The controller 1200 may include clock 1265, CPU 1270, memory such as read only memory (ROM) 1285 and random access memory (RAM) 1280, and co-processor 1275, among others. These controller components may be connected to a system bus 1260, and through the system bus 1260 to an interface bus 1235. Further, user input devices 1205, peripheral devices 1210, co-processor devices 1215, and the like, may be connected through the interface bus 1235 to the system bus 1260. The interface bus 1235 may be connected to a number of interface adapters, such as processor interface 1240, input/output (I/O) interfaces 1245, network interfaces 1250, storage interfaces 1255, and the like.

Processor interface 1240 may facilitate communication between co-processor devices 1215 and co-processor 1275. In one implementation, processor interface 1240 may expedite encryption and decryption of requests or data. Input/output (I/O) interfaces 1245 facilitate communication between user input devices 1205, peripheral devices 1210, co-processor devices 1215, and/or the like, and components of the controller 1200 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 1250 may be in communication with the network 1230. Through the network 1230, the controller 1200 may be accessible to remote terminal devices 1220. Network interfaces 1250 may use various wired and wireless connection protocols such as direct connect, Ethernet, wireless connection such as IEEE 802.11a-x, and the like.

Examples of networks 1230 include the Internet, Local Area Network (LAN), Metropolitan Area Network (MAN), a Wide Area Network (WAN), wireless network (e.g., using Wireless Application Protocol WAP), a secured custom connection, and the like. The network interfaces 1250 can include a firewall that can, in some aspects, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list that details permissions including, for example, the access and operation rights of an object by an individual, a machine, and/or an application, and the circumstances under which the permission rights stand. Other network security functions performed or included in the functions of the firewall can be, for example, but are not limited to, intrusion-prevention, intrusion detection, next-generation firewall, personal firewall, etc., without deviating from the novel art of this disclosure.

Storage interfaces 1255 may be in communication with a number of storage devices such as, storage devices 1290, removable disc devices, and the like. The storage interfaces 1255 may use various connection protocols such as Serial Advanced Technology Attachment (SATA), IEEE 1394, Ethernet, Universal Serial Bus (USB), and the like.

User input devices 1205 and peripheral devices 1210 may be connected to I/O interface 1245 and potentially other interfaces, buses and/or components. User input devices 1205 may include card readers, finger print readers, joysticks, keyboards, microphones, mouse, remote controls, retina readers, touch screens, sensors, and/or the like. Peripheral devices 1210 may include antenna, audio devices (e.g., microphone, speakers, etc.), cameras, external processors, communication devices, radio frequency identifiers (RFIDs), scanners, printers, storage devices, transceivers, and/or the like. Co-processor devices 1215 may be connected to controller 1200 through interface bus 1235, and may include microcontrollers, processors, interfaces or other devices.

Computer executable instructions and data may be stored in memory (e.g., registers, cache memory, random access memory, flash, etc.) that is accessible by processors. These stored instruction codes (e.g., programs) may engage the processor components, motherboard and/or other system components to perform desired operations. The controller 1200 may employ various forms of memory, including on-chip CPU memory (e.g., registers), RAM 1280, ROM 1285, and storage devices 1290. Storage devices 1290 may employ any number of tangible, non-transitory storage devices or systems such as fixed or removable magnetic disk drive, an optical drive, solid state memory devices, and other processor-readable storage media. Computer-executable instructions stored in the memory may include the virtual object platform 120, having one or more program modules such as routines, programs, objects, components, data structures, and so on that perform particular tasks or implement particular abstract data types. For example, the memory may contain operating system (OS) 1295, modules and other components, database tables, and the like. These modules/components may be stored and accessed from the storage devices, including from external storage devices accessible through an interface bus 1235.

The database components can store programs executed by the processor to process the stored data. The database components may be implemented in the form of a database that is relational, scalable and secure. Examples of such a database include DB2, MySQL, Oracle, Sybase, and the like. Alternatively, the database may be implemented using various standard data-structures, such as an array, hash, list, stack, structured text file (e.g., XML), table, and/or the like. Such data-structures may be stored in memory and/or in structured files.

The controller 1200 may be implemented in distributed computing environments, where tasks or modules are performed by remote processing devices, which are linked through a communications network, such as a Local Area Network (LAN), Wide Area Network (WAN), the Internet, and the like. In a distributed computing environment, program modules or subroutines may be located in both local and remote memory storage devices. Distributed computing may be employed to load balance and/or aggregate resources for processing. Alternatively, aspects of the controller 1200 may be distributed electronically over the Internet or over other networks (including wireless networks). Those skilled in the relevant art(s) will recognize that portions of the virtual object platform 130 may reside on a server computer, while corresponding portions reside on a client computer. Data structures and transmission of data particular to aspects of the controller 1200 are also encompassed within the scope of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1-20. (canceled)

21. A virtual object platform comprising:
a processor;
a database comprising multiple virtual customization profiles configured to guide a creator through a creation of a unique virtual object;
a customization module, configured to
retrieve, from the database, one of the multiple virtual customization profiles to guide the creator through creation of the unique virtual object; and
issue the unique virtual object with a unique identifier allowing for identification of the unique virtual object; and
a distribution module, configured to record the unique virtual object within a blockchain system, wherein the recordation comprises initial ownership information for the unique virtual object, and wherein the blockchain system is configured to maintain state information for the unique virtual object;
wherein the processor is configured to
receive a request to modify the state information of the unique virtual object;
access the blockchain system to retrieve the state information associated with the unique virtual object; and
process the request to modify the state information.

22. The virtual object platform of claim 21, wherein the customization module is configured to allow the creator to set one or more rules governing evolution of the unique virtual obj ect.

23. The virtual object platform of claim 22, wherein the one or more rules governing the evolution of the unique virtual object include a rule for combining two different unique virtual obj ects.

24. The virtual object platform of claim 21, wherein the customization module is configured to allow the creator to associate software code with the unique virtual object and the distribution module is configured to record the software code with the blockchain system.

25. The virtual object platform of claim 21, wherein virtual customization profile is configured to allow the creator to create or select one or more visual customizations, audio customizations, and/or content customizations for the unique virtual object.

26. The virtual object platform of claim 21, further comprising an internal viewer application configured to allow the creator to view and interact with the unique virtual object in connection with one or more simulated events or actions.

27. The virtual object platform of claim 21, further comprising one or more external viewer applications configured to:
identify unique virtual objects associated with a user;
retrieve the state information from the blockchain system; and
generate a visualization of the unique virtual object based on the state information.

28. A non-transitory computer-readable medium comprising computer-executable instructions that when executed cause a processor to:
receive a request to modify a unique virtual object that has state information recorded in a blockchain system, wherein the unique virtual object is associated with a modification rule set governing permissible modifications for the unique virtual object;
retrieve, from the blockchain system, the state information for the unique virtual object;
process the request to modify the unique virtual object subject to the modification rule set for the unique virtual object;
generate updated state information based on any modification to the unique virtual object; and
store the updated state information in the blockchain system.

29. The non-transitory computer-readable medium of claim 28, wherein the request includes a unique identifier identifying the unique virtual object.

30. The non-transitory computer-readable medium of claim 28, wherein the request to modify the unique virtual object originates from a viewer application running on a computing device in response to a user interacting with a representation of the unique virtual object provided by an external source, and the request includes a change in ownership of the unique virtual object to the user of the viewer application.

31. The non-transitory computer-readable medium of claim 30, wherein the external source is a television stream, a billboard, an audio signature, a printed document or a website.

32. The non-transitory computer-readable medium of claim 28, wherein the request identifies two virtual objects to be combined.

33. The non-transitory computer-readable medium of claim 28, wherein the state information stored in the blockchain system also includes software code that can be retrieved and executed by a viewer application.

34. The non-transitory computer-readable medium of claim 33, wherein the viewer application is an augmented reality or virtual reality viewer.

35. The non-transitory computer-readable medium of claim 28, wherein the unique virtual object is associated with or a representation of a virtual currency.
